(19) United States
(12) Patent Application Publication
(10) Pub. No.: US 2026/0012985 A1
(43) Pub. Date: Jan. 8, 2026

(54) METHOD AND SYSTEM OF ESTABLISHING BLUETOOTH LOW ENERGY CONNECTION BY USING OFFSET NEGOTIATION TECHNIQUE

(71) Applicant: Samsung Electronics Co., Ltd., Suwon-si (KR)

(72) Inventor: Manjunath Subhedar Rudrappa, Bengaluru (IN)

(21) Appl. No.: 19/260,372

(22) Filed: Jul. 4, 2025

(30) Foreign Application Priority Data
Jul. 4, 2024 (IN) 202441051385
Jul. 3, 2025 (IN) 202441051385

(51) Int. Cl. H04W 76/10; H04W 4/80

(52) U.S. Cl. CPC H04W 76/10; H04W 4/80

(57) ABSTRACT

A method of avoiding data packet collisions includes initiating, by a first electronic device, a Hands-Free-Profile (HFP) call event between the first electronic device and a third electronic device through a second electronic device, wherein the second electronic device and the third electronic device communicate using an extended Synchronous Connection-Oriented (eSCO) communication link during one or more pre-defined eSCO time intervals, establishing, by the first electronic device, a Bluetooth Low Energy (BLE) communication link with the second electronic device while the HFP call event is active, and in response to the establishing of the BLE communication link, configuring, by the first electronic device, one or more BLE time intervals to exchange one or more BLE data packets between the first and second electronic devices. The BLE time intervals are distinct from the eSCO time intervals to avoid the data packet collisions.

### CROSS-REFERENCE TO RELATED APPLICATION

This application claims priority under 35 U.S.C. § 119 to Indian Provisional Patent Application No. 20/244,1051385, filed on Jul. 4, 2024 and Indian Non-Provisional patent application Ser. No. 20/244,1051385 filed on Jul. 3, 2025 in the Indian Intellectual Property Office, the disclosure of each of which is incorporated by reference herein in its entirety.

### FIELD OF THE INVENTION

The present invention generally relates to the field of wireless communication systems, and more specifically relates to a method and a system for establishing Bluetooth Low Energy (BLE) connection by using an offset negotiation technique.

### BACKGROUND

The information disclosed in this background section is only for enhancement of understanding of the general background of the disclosure and should not be taken as an acknowledgement or any form of suggestion that this information forms the prior art already known to a person skilled in the art.

Bluetooth Low Energy (BLE) is a wireless communication technology designed for short-range connectivity, emphasizing low power consumption and efficient data transfer, which operates within a 2.4 GHz Industrial, Scientific, and Medical (ISM) band. The BLE is ideal for electronic devices like wearables and smart home gadgets, allowing such devices to remain in a sleep mode for extended periods while minimizing energy use. In the context of wireless communication technology, extended Synchronous Connection-Oriented (eSCO) links are tailored for high-quality audio transmission, enhancing voice communication with reduced latency. The eSCO links extend capabilities of Synchronous Connection-Oriented (SCO) links by enabling flexible data packet transmission and simultaneous bidirectional communication.

In the context of the BLE, a Hands-Free Profile (HFP) facilitates hands-free communication between mobile devices and accessories, such as car audio systems or Bluetooth headsets. The HFP leverages the eSCO links to ensure high-quality audio during calls, minimizing latency for real-time interaction. While the BLE can manage call-related data such as caller ID and status, it is not suitable for audio transmission due to its limited bandwidth. By combining BLE for data signaling with eSCO for audio, Bluetooth technologies work together to deliver efficient and high-performance hands-free communication, enhancing the overall user experience across applications. However, several problems are encountered in the existing systems or applications, which are mentioned below.

The existing systems and applications face several challenges, particularly in scenarios involving multiple electronic devices communicating with one another, as illustrated in FIG. 1. For instance, consider a scenario where a user is running on a treadmill and receives a call on a smartphone 101, the user can answer the call via a smartwatch 102, with audio transmitted through a Bluetooth headset 103. In one scenario (e.g., BLE communication link), the smartphone 101 acts as a central device, connecting various peripherals such as the smartwatch 102. In another scenario (e.g., eSCO communication link and BLE communication link), the smartphone 101 manages calls through the smartwatch 102, as an intermediary for hands-free calling. The smartwatch 102 acts as the central device for the Bluetooth headset 103 while also functioning as the peripheral to the smartphone 101. The smartwatch 102 utilizes an embedded SIM (eSIM) functionality provided by the smartphone 101 to independently manage cellular services. The Bluetooth headset 103 connects to either the smartphone 101 via a BLE communication link 104 or the smartwatch 102 via an eSCO communication link 105, acting as the peripheral receiving one or more commands from the smartphone 101 or the smartwatch 102 and transmitting audio signals back to the smartphone 101 or the smartwatch 102.

Simultaneously, during the running on the treadmill, the user may wish to synchronize health data collected by the smartwatch 102 to the smartphone 101 using the BLE communication link 104. For example, the smartwatch 102 continuously collects health data, including heart rate, step count, sleep logs, and workout metrics, synchronizing this information periodically with the smartphone 101 over the BLE communication link 104 using Generic Attribute Profile (GATT) long reads/writes or BLE notifications.

However, complications arise when the user makes or receives voice calls using the Bluetooth headset 103, which operates under the HFP. In such instances, a Bluetooth controller of the smartphone 101 is required to manage both HFP audio streaming (i.e., through the eSCO communication link 105) and BLE data transmission (i.e., through the BLE communication link 104). This leads to conflicts that occur due to time slot scheduling and bandwidth limitations, disrupting the BLE communication link 104 (i.e., a BLE connection) to the smartwatch 102, as illustrated in FIGS. 2A-2B. This results in synchronization failures, leading to missing data logs, such as run or sleep sessions, and causing latency-sensitive health data, like heart rate variability or ECG readings, to become unreliable. Additionally, such scenario increases battery drain on the smartwatch 102 due to repeated connection attempts. Thereby impacting user experience, particularly for fitness and health-conscious users who may miss critical alerts.

Thus, it is desired to address the above-mentioned disadvantages or other shortcomings or at least provide a useful alternative for establishing the BLE connection in scenarios involving multiple electronic devices communicating with one another.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an aspect of the present disclosure, a method of avoiding data packet collisions includes initiating, by a first electronic device, a Hands-Free-Profile (HFP) call event between the first electronic device and a third electronic device through a second electronic device, wherein the second electronic device and the third electronic device communicate using an extended Synchronous Connection-Oriented (eSCO) communication link to exchange one or more eSCO data packets during one or more pre-defined eSCO time intervals, establishing, by the first electronic device, a Bluetooth Low Energy (BLE) communication link with the second electronic device while the HFP call event is active between the second electronic device and the third electronic device, and in response to the establishing of the BLE communication link, configuring, by the first electronic device, one or more BLE time intervals to exchange one or more BLE data packets between the first electronic device and the second electronic device. The one or more BLE time intervals are distinct from the one or more pre-defined eSCO time intervals to avoid the data packet collisions between the one or more BLE data packets and the one or more eSCO data packets.

According to an aspect of the present disclosure, a system for avoiding data packet collisions between a BLE data packet and an eSCO data packet includes a memory, a processor, a communicator circuit, and a BLE-eSCO communication controller circuit operably connected to the memory, the processor, and the communicator circuit and configured to initiate, by a first electronic device, a Hands-Free-Profile (HFP) call event between the first electronic device and a third electronic device through a second electronic device, wherein the second electronic device and the third electronic device communicate using an extended Synchronous Connection-Oriented (eSCO) communication link to exchange one or more eSCO data packets during one or more pre-defined eSCO time intervals, establish a Bluetooth Low Energy (BLE) communication link with the second electronic device while the HFP call event is active between the second electronic device and the third electronic device, and in response to the establishing of the BLE communication link, configure one or more BLE time intervals to exchange one or more BLE data packets between the first electronic device and the second electronic device. The one or more BLE time intervals are distinct from the one or more pre-defined eSCO time intervals to avoid the data packet collisions. Each of the first electronic device and the second electronic device includes the system.

According to an aspect of the present disclosure, a smartphone includes a memory, a processor, a communicator circuit, and a BLE-eSCO communication controller circuit operably connected to the memory, the processor, and the communicator circuit, and configured to initiate a Hands-Free-Profile (HFP) call event between the smartphone and a first peripheral device through a second peripheral device that is connected to the first peripheral device using an extended Synchronous Connection-Oriented (eSCO) communication link to exchange at least one eSCO data packet during a pre-defined eSCO time interval, establish a Bluetooth Low Energy (BLE) communication link with the first peripheral device while the HFP call event is active between the peripheral device and the second peripheral device, and in response to the establishing of the BLE communication link, configure at least one BLE time interval to exchange at least one BLE data packet between the first smartphone and the first peripheral device. The at least one BLE time interval is distinct from the at least one pre-defined eSCO time interval to avoid data packet collision between the at least one BLE data packet and the at least one eSCO data packet.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a synchronization failure scenario that occurs among multiple electronic devices while communicating over Extended Synchronous Connection-Oriented (eSCO) links and Bluetooth Low Energy (BLE) communication links simultaneously, according to a related art;

FIG. 2A is a flow diagram that illustrates a problem associated with a method for establishing eSCO and BLE communication links simultaneously for multiple electronic devices, according to a related art;

FIG. 2B illustrates a time frame analysis related to the synchronization failure as illustrated in FIG. 1, according to a related art;

FIG. 3 illustrates a block diagram of an electronic device for avoiding data packet collisions, according to an embodiment as disclosed herein;

FIG. 4 illustrates a first packet retry technique, according to an embodiment as disclosed herein;

FIG. 5 illustrates an offset re-negotiation technique for establishing eSCO and BLE communication links simultaneously for multiple electronic devices, according to an embodiment as disclosed herein;

FIG. 6 illustrates a time frame analysis related to the offset re-negotiation technique, according to an embodiment as disclosed herein;

FIG. 7 illustrates a disproportionate connection intervals technique for establishing eSCO and BLE communication links simultaneously for multiple electronic devices, according to an embodiment as disclosed herein;

FIG. 8 illustrates an eSCO TX/RX technique for establishing eSCO and BLE communication links simultaneously for multiple electronic devices, according to an embodiment as disclosed herein; and

FIG. 9 is a flow diagram illustrating a method for avoiding data packet collisions, according to an embodiment as disclosed herein.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF FIGURES

For the purpose of promoting an understanding of the principles of the invention, reference will now be made to the embodiment illustrated in the drawings and specific language will be used to describe the same. However, it will be understood that the invention is not limited to the specific embodiments described and illustrated herein. Various modifications and adaptations, as well as alternative applications of the invention's principles, will be apparent to those skilled in the art and are considered within the scope of the invention.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is customary in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally used only to distinguish one element from another.

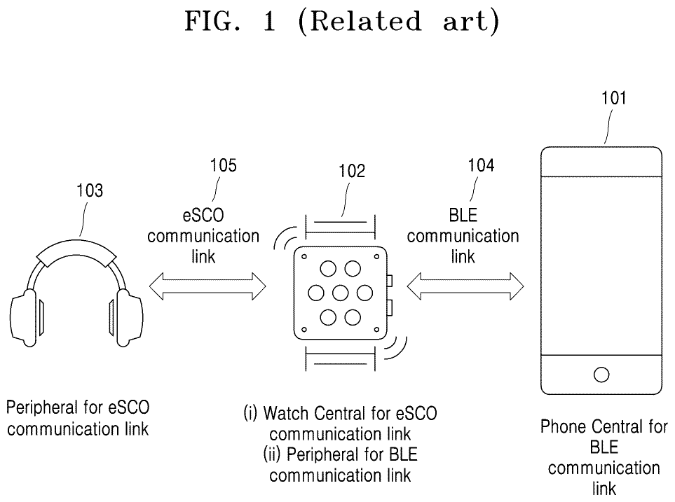

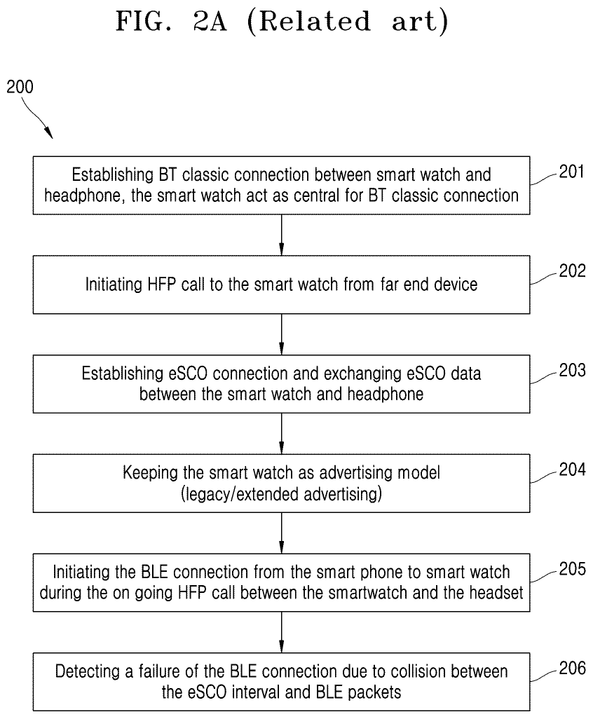

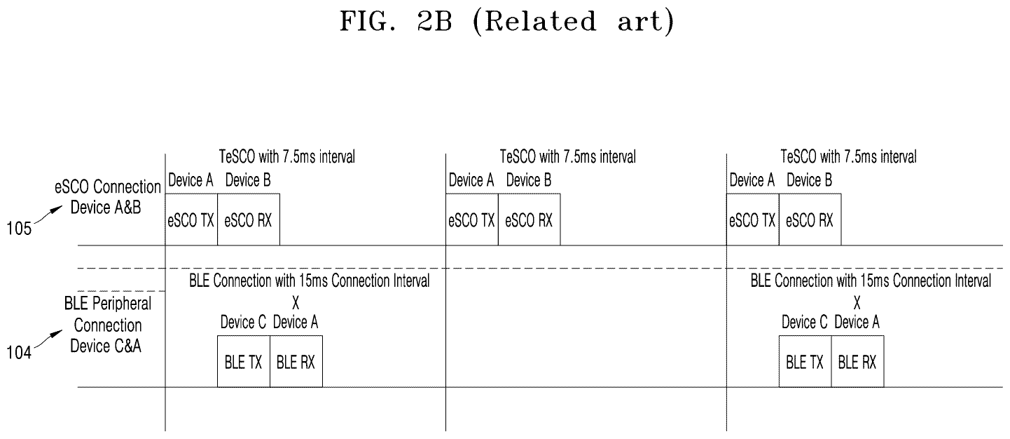

FIG. 2A is a flow diagram that illustrates a problem associated with a method 200 for establishing eSCO and BLE communication links simultaneously for multiple electronic devices, according to a related art. The method 200 may be performed by electronic devices, such as the smartphone 101, the smartwatch 102, and the Bluetooth headset 103, as described in reference to FIG. 1.

At operation 201, the method 200 includes establishing a Bluetooth Classic connection between the smartphone 101 and the Bluetooth headset 103. In this setup, the smartphone 101 acts as the central device for the Bluetooth classic connection. At operation 202, the method 200 includes initiating a Hands-Free Profile (HFP) call from a remote device (e.g., smartphone 101) to the smartwatch 102. This allows voice communication through the smartwatch 102. At operation 203, the method 200 includes establishing an Enhanced Synchronous Connection-Oriented (eSCO) connection, allowing for an exchange of eSCO data between the smartwatch 102 and the Bluetooth headset 103. This eSCO connection is crucial for transmitting audio data with low latency.

At operation 204, the method 200 includes broadcasting by the smartwatch 102. For example, the smartwatch 102 is configured to act as an advertising device, using either legacy or extended advertising methods. This enables the smartwatch 102 to broadcast its presence to nearby BLE devices (e.g., the smartphone 101). At operation 205, the method 200 includes initiating, during the ongoing HFP call between the smartwatch 102 and the Bluetooth headset 103, a BLE connection from the smartphone 101 to the smartwatch 102. This allows the smartphone 101 to communicate with the smartwatch 102 while the call is active. At operation 206, the method 200 includes detecting a failure in the BLE connection. Such failures may occur due to collisions between the eSCO intervals and BLE packets, which can disrupt communication, as illustrated in FIG. 2B.

For instance, consider an example scenario in which a user (Jack) relies on his smartwatch 102, Bluetooth headset 103, and smartphone 101 to stay connected during his morning commute. As he prepares to leave, he puts on his Bluetooth headset 103 and turns on his smartwatch 102. The smartwatch 102 establishes the Bluetooth classic connection with the Bluetooth headset 103, enabling hands-free calling. While on the bus, Jack receives a call from his colleague. The call is initiated from the colleague's phone to Jack's smartwatch 102 using the HFP. Jack answers the call through his Bluetooth headset 103, allowing for clear communication without using his hands. During the call, the smartwatch 102 set up the eSCO communication link 105 with the Bluetooth headset 103. This connection ensures high audio quality and minimal delay, which are crucial for effective conversation. Meanwhile, the smartwatch 102 is configured to act as an advertising device, broadcasting its presence to nearby BLE-capable devices. As Jack continues his call, he receives a notification on his smartphone 101 about achieving a new fitness goal. He establishes the BLE communication link 104 from his smartphone 101 to the smartwatch 102 to synchronize this fitness data while the HFP call remains active. This allows him to receive fitness notifications without interrupting the ongoing call. However, during this simultaneous operation, the collision occurs between the eSCO data packets and the BLE packets. The smartwatch 102 detects a failure in the BLE communication link 104 due to the overlap in communication intervals, causing Jack to notice a brief delay in receiving the fitness notification on his smartwatch 102, which can lead to a poor user experience.

FIG. 2B illustrates a time frame analysis related to the synchronization failure as illustrated in FIG. 1, according to a related art. FIG. 2B illustrates two types of Bluetooth connections (links), for example, the eSCO communication link 105 and the BLE communication link 104. The eSCO communication link 105 between the Device A (e.g., smartwatch 102) and the Device B (e.g., Bluetooth headset 103) has a 7.5 ms interval, while the BLE communication link 104 between Device C (e.g., smartphone 101) and Device A (e.g., smartwatch 102) has a 15 ms connection interval, and the BLE connection interval of 15 ms is a multiple of eSCO interval of 7.5 ms. As a result, the connection intervals between the eSCO and BLE connections can lead to a collision scenario. Specifically, eSCO TX (transmit) and eSCO RX (receive) activities for Device A and Device B overlap with BLE TX and BLE RX activities for Device C and Device A. This overlap can result in potential collisions and interference between the two types of connections, which can cause data loss, connection instability, and reduced overall performance.

In other words, a BLE connection interval of 30 ms is the multiple of the eSCO interval of 7.5 ms. Also, both Bluetooth connections have different clock drift/accuracy. This drift eventually leads to a collision between the anchor points of these two Bluetooth connections. Therefore, the device (e.g., smartwatch 102) cannot maintain the BLE link as it prioritizes eSCO reserved slots. This results in connection drift, which may lead to collision with the reserved eSCO time slots.

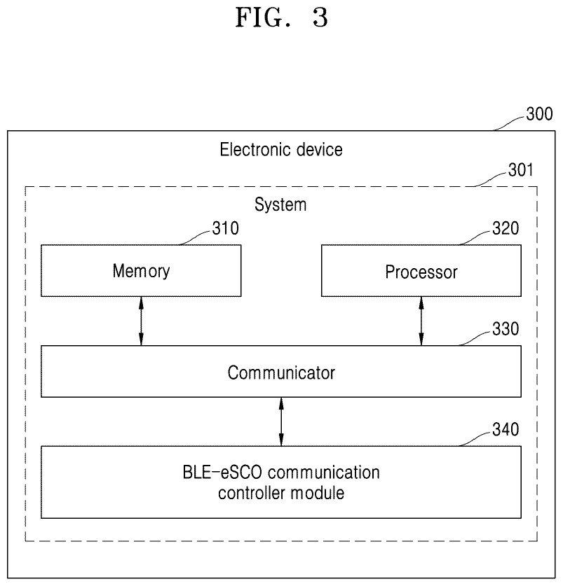

To address these challenges, the present disclosure provides a method with a unique strategy for establishing Bluetooth Low Energy (BLE) connections by using an offset negotiation technique, as described in conjunction with FIGS. 3 to 9.

Referring now to the drawings, and more particularly to FIGS. 3 to 9, where similar reference characters denote corresponding features consistently throughout the figures, there are shown preferred embodiments.

FIG. 3 illustrates a block diagram of an electronic device 300 for avoiding data packet collisions, according to an embodiment as disclosed herein. Examples of the electronic device 300 include, but are not limited to a smartphone, a tablet computer, a Personal Digital Assistance (PDA), an Internet of Things (IOT) device, a smartwatch, a Bluetooth headset, a wearable device, etc.

In some example embodiments, the electronic device 300 comprises a system 301. The system 301 may include a memory 310, a processor 320, a communicator 330 (i.e., a communicator circuit), and a BLE-eSCO communication controller module 340 (i.e., a BLE-eSCO communication controller circuit). In one or more embodiments, the system 301 may be implemented on one or multiple electronic devices (not shown in FIG. 3). For example, when the system 301 is implemented on multiple electronic devices, each of the multiple electronic devices may include the system 301. In an embodiment, in FIG. 1, each of the smartphone 101 and the smartwatch 102 may have the system 301 according to the present inventive concept.

In some example embodiments, the electronic device 300 may relate to at least one of a first electronic device, a second electronic device, and a third electronic device.

In some example embodiments, the memory 310 stores instructions to be executed by the processor 320 for establishing Bluetooth Low Energy (BLE) connection by using an offset negotiation technique, as discussed throughout the disclosure. The memory 310 may include non-volatile storage elements. Examples of such non-volatile storage elements may include magnetic hard discs, optical discs, floppy discs, flash memories, electrically programmable memories (EPROM), or electrically erasable and programmable (EEPROM) memories. In addition, the memory 310 may, in some examples, be considered a non-transitory storage medium. The term “non-transitory” may indicate that the storage medium is not embodied in a carrier wave or a propagated signal. However, the term “non-transitory” should not be interpreted that the memory 310 is non-movable. In some examples, the memory 310 may be configured to store larger amounts of information than the memory. In certain examples, a non-transitory storage medium may store data that can, over time, change (e.g., in Random Access Memory (RAM) or cache). The memory 310 may be an internal storage unit, or it may be an external storage unit of the electronic device 300, a cloud storage, or any other type of external storage.

In some example embodiments, the processor 320 communicates with the memory 310, the communicator 330, and the BLE-eSCO communication controller module 340. The processor 320 is configured to execute instructions stored in the memory 310 and to perform various processes for establishing the BLE connection by using the offset negotiation technique as discussed throughout the disclosure. The processor 320 may include one or a plurality of processors, may be a general-purpose processor, such as a Central Processing Unit (CPU), an Application Processor (AP), or the like, a graphics-only processing unit such as a Graphics Processing Unit (GPU), a Visual Processing Unit (VPU), and/or an Artificial Intelligence (AI) dedicated processor such as a Neural Processing Unit (NPU).

In some example embodiments, the communicator 330 is configured for communicating internally between internal hardware components and with external devices (e.g., server) via one or more networks (e.g., radio technology). The communicator 330 includes an electronic circuit specific to a standard that enables wired or wireless communication such as Bluetooth, Wi-Fi, and Ethernet.

In some example embodiments, the system 301 may include a display module (not shown in FIG. 3). The display module may accept user inputs and include a Liquid Crystal Display (LCD) display, a Light Emitting Diode (LED) display, an Organic Light Emitting Diode (OLED) display, or another type of display. The user inputs may include but are not limited to, touch, swipe, drag, gesture, and so on.

In some example embodiments, the BLE-eSCO communication controller module 340 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In some example embodiments, the BLE-eSCO communication controller module 340 may initiate, by the first electronic device, a Hands-Free-Profile (HFP) call event between the first electronic device (e.g., smartphone) and a third electronic device (e.g., a Bluetooth headphone with a microphone) through a second electronic device (e.g., a smartwatch). The second electronic device and the third electronic device communicate using an extended Synchronous Connection-Oriented (eSCO) communication link to exchange one or more eSCO data packets during one or more pre-defined eSCO time intervals.

In some example embodiments, the first electronic device operates as a central device, connecting peripheral devices comprising the second electronic device and the third electronic device, to manage a call via a traditional technique or by using the second electronic device as an intermediary for hands-free calling experiences.

In some example embodiments, the second electronic device may operate as a central device for the third electronic device while also operating as the peripheral device to the first electronic device.

In some example embodiments, the third electronic device connects to either the first electronic device or the second electronic device and operates as the peripheral device that receives one or more commands and transmits audio signals back.

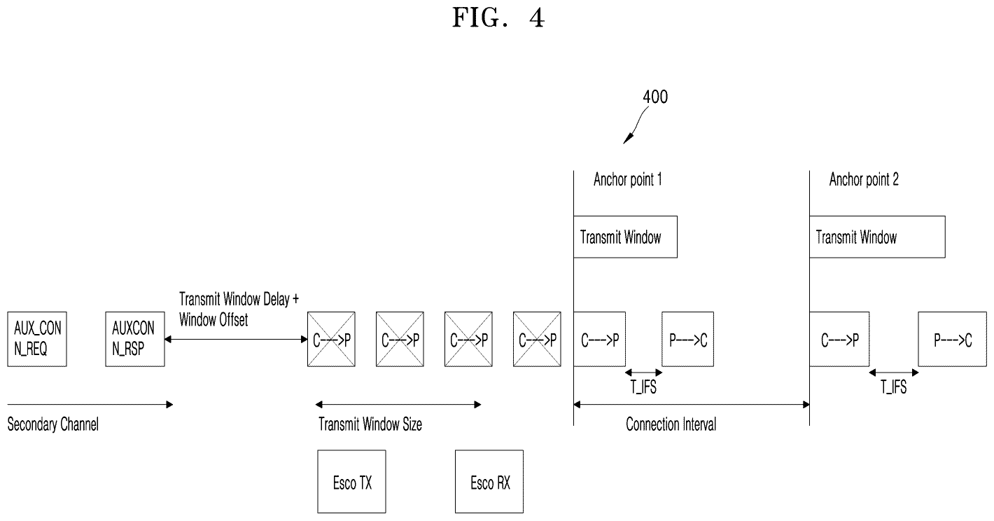

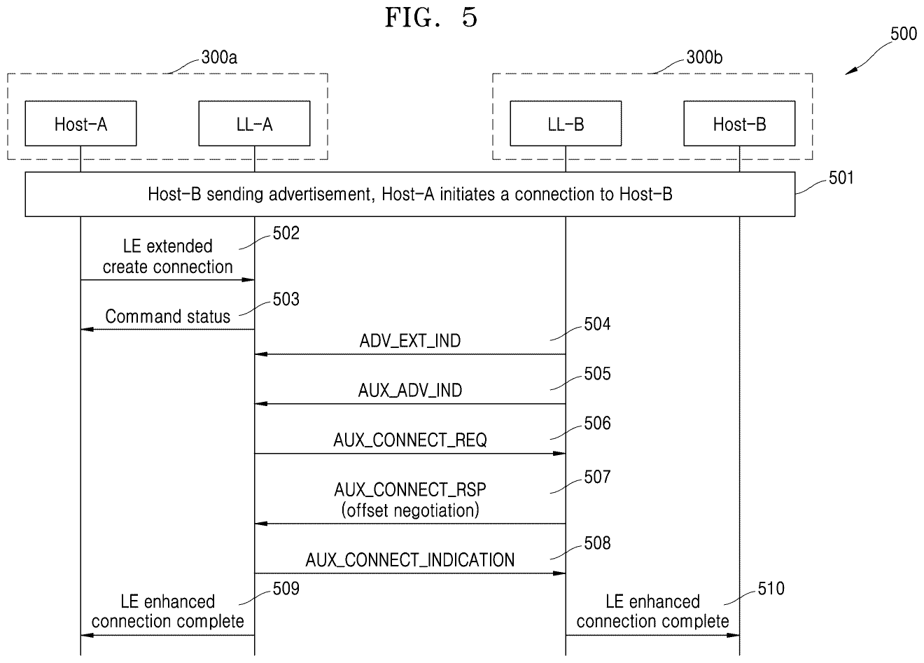

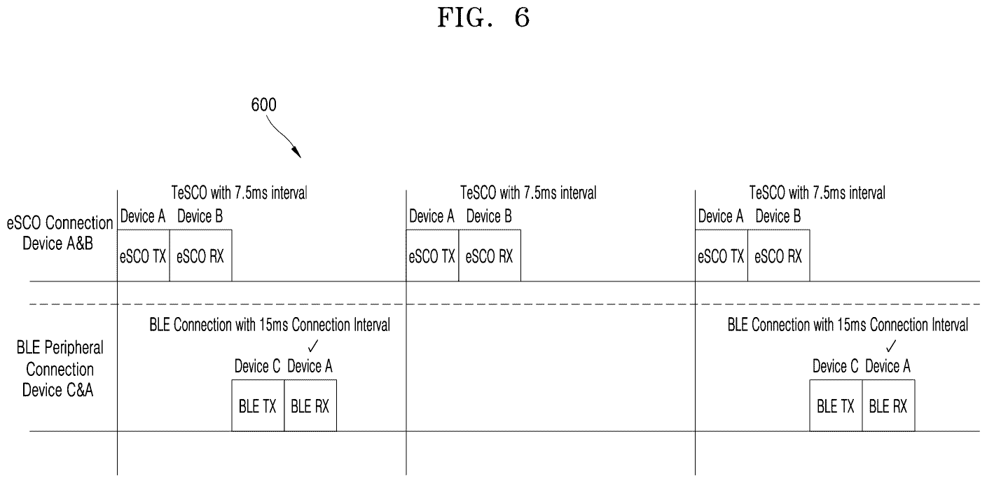

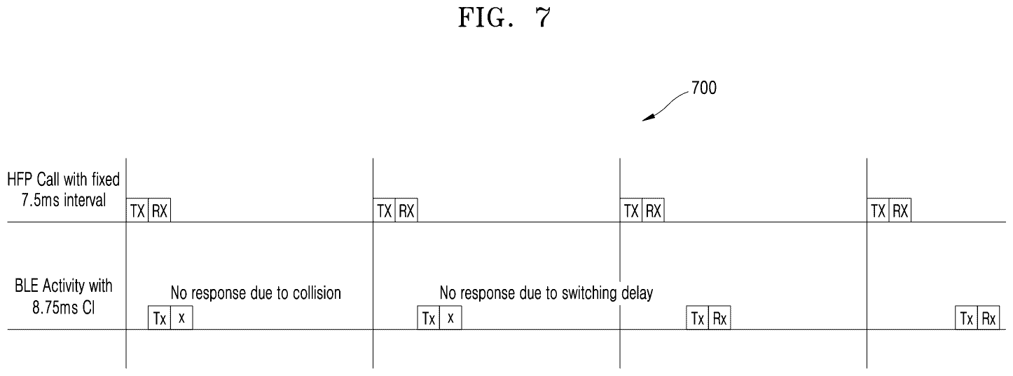

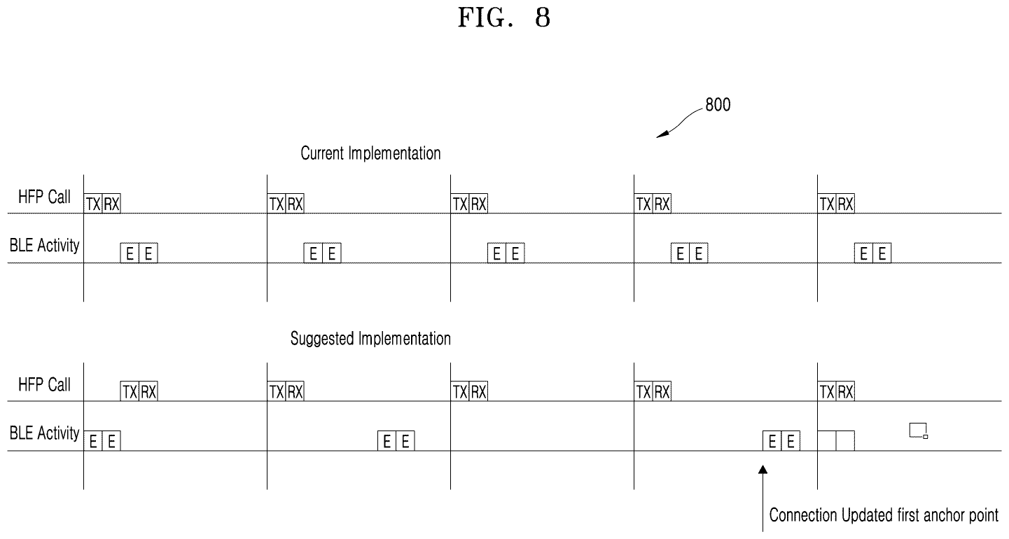

In some example embodiments, the BLE-eSCO communication controller module 340 may establish, by the first electronic device, a Bluetooth Low Energy (BLE) communication link with the second electronic device while the HFP call event is active between the second electronic device and the third electronic device. The BLE-eSCO communication controller module 340 may further configure, by the first electronic device, one or more BLE time intervals to exchange one or more BLE data packets between the first electronic device and the second electronic device in response to establishing the BLE communication link, as described in conjunction with FIG. 4, FIG. 5, FIG. 6, FIG. 7, and FIG. 8. The one or more BLE time intervals are distinct from the one or more pre-defined eSCO time intervals to avoid data packet collisions. For example, the one or more BLE time intervals do not overlap the one or more pre-defined eSCO time intervals.

In some example embodiments, the BLE-eSCO communication controller module 340 may retry, by the first electronic device, BLE communication link establishment after the failure of a first connection establishment attempt, as described in conjunction with FIG. 4.

In some example embodiments, to configure the one or more BLE time intervals to exchange the one or more BLE data packets between the first electronic device and the second electronic device, the BLE-eSCO communication controller module 340 may transmit, by the first electronic device, a connection request to the second electronic device. The BLE-eSCO communication controller module 340 may further receive a response message (e.g., AUX_CONNECT_RSP PDU) from the second electronic device for offset negotiation in response to transmitting the connection request, as described in conjunction with FIG. 5. The response message may include a payload that comprises an extended header length, an Advertising Mode (Adv Mode), and an extended header. The extended header comprises several values corresponding to an advertising mode, an event type, an Advertising Address (Adv A), a Target Address (Target A), a minimum offset value (Offset Min), a maximum offset value (Offset Max), an Auxiliary Pointer value (Aux Ptr), Synchronization Information (Sync Info), Transmit Power value (Tx Power), Advertising Channel Assessment Data (ACAD), and Advertising Data (Adv Data).

In some example embodiments, the BLE-eSCO communication controller module 340 may further transmit an indication message (e.g., AUX_CONNECT_IND) to the second electronic device to configure the one or more BLE time intervals to exchange one or more BLE data packets between the first electronic device and the second electronic device in response to receiving the response message, as described in conjunction with FIG. 5. The indication message may include a payload that comprises an Initial Address (Init A), an Advertising Address (Adv A), and Link Layer Data (LLData). The LLData comprises several values corresponding to Access Address (AA), CRC Initialization (CRCInit), Window Size (WinSize), Window Offset (WinOffset), Interval, Latency, Timeout, Channel Map (ChM), Hop value, and Sleep Clock Accuracy (SCA).

In some example embodiments, to configure the one or more BLE time intervals to exchange the one or more BLE data packets between the first electronic device and the second electronic device, the BLE-eSCO communication controller module 340 may determine, by the first electronic device, the one or more pre-defined eSCO time intervals. The BLE-eSCO communication controller module 340 may further determine, by the first electronic device, the one or more BLE time intervals that are distinct or disproportionate from the one or more pre-defined eSCO time intervals to avoid data packet collisions, as described in conjunction with FIG. 7.

In some example embodiments, to configure the one or more BLE time intervals to exchange the one or more BLE data packets between the first electronic device and the second electronic device, the BLE-eSCO communication controller module 340 may perform, by the second electronic device, one or more operations, as described in conjunction with FIG. 8.

Although FIG. 3 shows various hardware components of the electronic device 300, it is to be understood that other embodiments are not limited thereon. In other embodiments, the electronic device 300 may include less or a greater number of components. Further, the labels or names of the components are used only for illustrative purposes and do not limit the scope of the invention. One or more components can be combined to perform the same or substantially similar functions for establishing the BLE connection by using the offset negotiation technique.

FIG. 4 illustrates a first packet retry technique 400, according to an embodiment as disclosed herein. In the context of the first packet retry technique, a first packet sent by a central electronic device (e.g., electronic device 300/BLE-eSCO communication controller module 340), such as a smartphone or computer, may exceed a designated transmit window, necessitating that a peripheral electronic device, like a smartwatch or sensor, be prepared for this scenario. The first packet received by the peripheral device is critical as it establishes an anchor point for an initial connection event, determining a timing for all subsequent connection events during a session. In an embodiment, the session may refer to a period during which two entities (e.g., a smartphone and a smartwatch) maintain an active communication link to exchange data or perform tasks. To recognize the first packet, the peripheral device only needs to verify that the access address matches, regardless of whether a Cyclic Redundancy Check (CRC) is valid. In an embodiment, if the access address in the received packet matches its own connection's access address, the packet is accepted, and otherwise, the received packet is ignored.

If the first packet is not received within the designated transmit window, the peripheral device may attempt to receive it in a next available transmit window and must actively listen for the central device's transmission during this period. The central device has the flexibility to send this first packet at random times, meaning that the timing can vary. This initial packet from the central device initiates a connection event, even if the peripheral does not respond immediately. The central device may keep retrying to send this first packet multiple times within the transmit window duration until it receives a response from the peripheral device and maps the start time of this packet as a first anchor point. In addition, the first packet can extend beyond a size of the transmit window without violating Bluetooth specifications, allowing for more flexible communication and ensuring effective connection establishment.

The following example illustrates the process of the first packet retry technique 400 in a BLE peripheral connection, highlighting interactions with a Link Layer (LL) and key BLE parameters, as shown in Table-a.
a. Initial transmission (failed): The central electronic device sends a packet with a sequence number (“SN-0”), expecting an acknowledgment sequence number (“NESN=0”). However, the packet is lost, and the peripheral electronic device does not send an acknowledgment (ACK).
b. Retry technique triggered: The central electronic device detects that the expected ‘NESN’ has not incremented (it remains “0”). As a result, it retransmits the same packet (“SN-0”) during the next connection event.
c. Successful retry: The peripheral electronic device receives the retransmitted packet and responds with an acknowledgment (“LL_ACK”), updating its “NESN” to “1”.
d. Normal operation resumes: The central electronic device can now send the next packet (“SN=1”), with the updated “NESN=1”.

TABLE a

| Central electronic device | Peripheral electronic device |
|---|---|
| \| | \| |
| \| --(1) LL Data Packet [SN=0, NESN=0]----> | \| (First transmission) |
| | \| |
| \| (Packet lost due to interference) | \| |
| \| | \| |
| \| --(2) No ACK received (NESN remains 0) | \| |
| \| | \| |
| \| --(3) Retry in next connInterval ------> | \| (Retransmission) |
| \| LL Data Packet [SN=0, NESN=0] | \| |
| \| | \| |
| \| (Packet successfully received) | \| |
| \| | \| |
| \| <--(4) LL_ACK [NESN=1]----------------- | \| (Acknowledgment) |
| \| | \| |
| \| --(5) Next Packet [SN=1, NESN=1]-------> | \| (Normal operation) |
| \| | \| |

The peripheral electronic device may start to listen for the first packet within the transmit window. While doing so, it shall perform the window widening specified. The central electronic device's first packet can extend beyond the transmit window, and therefore the peripheral electronic device must take this into account. Regardless of a valid CRC match, when the first packet received matches the access address, in a connection state by the peripheral electronic device, the anchor point for the first connection event, and the timings of all future connection events in this connection may be determined using the first packet. For example, the peripheral electronic device may start listening for the first packet within the defined transmit window, applying window widening as specified to compensate for potential clock drift. Although the central electronic device is expected to transmit the first packet within the transmit window, the transmission may extend slightly beyond this window. Accordingly, the peripheral device may account for such variations. The first packet received by the peripheral device while in the connection state—provided that the access address matches, irrespective of CRC validity—defines the anchor point for the initial connection event. This anchor point subsequently determines the timing of all future connection events within the session.

If a packet is not received in the transmit window, the peripheral electronic device may attempt to receive a packet in a subsequent transmit window. In the next connection interval, a subsequent transmit window may start after the start of the previous transmit window, with the same transmit window size.

FIG. 5 illustrates an offset re-negotiation technique 500 for establishing eSCO and BLE communication links simultaneously for multiple electronic devices, according to an embodiment as disclosed herein. The offset re-negotiation technique 500 may include a sequence of events/operations during a Bluetooth advertising and connection establishment process between two Bluetooth devices, referred to as Host-A 300a and Host-B 300b.

At operation 501, the Host-B 300b broadcasts an advertisement message, which is a fundamental Bluetooth operation to make its presence known to other nearby Bluetooth devices. Upon receiving the advertisement from the Host-B 300b, the Host-A 300a decides to initiate a connection with the Host-B 300b. This is the first operation in establishing a Bluetooth link between the two devices.

At operation 502, the Host-A 300a sends an LE extended connection create command to initiate the connection establishment process. The LE extended connection create command which may refer to enhancements in connection management introduced in Bluetooth 5.0 and later versions. These enhancements primarily focus on improving data throughput, connection update efficiency, and range, without significantly impacting power consumption. This command includes various parameters to configure connection between the Host-A 300a and the Host-B 300b, such as the connection interval, supervision timeout, and other link-layer settings. At operation 503, the devices exchange Command Status messages to acknowledge the receipt and processing of the LE extended connection create command. The LE Enhanced connection may refer to enhancements in Bluetooth Low Energy (BLE) connections, primarily introduced with Bluetooth 5.0 and later, that provide improved performance, flexibility, and reliability for BLE communication.

At operations 504-508, a series of Bluetooth link-layer control messages are exchanged between the Host-A 300a and the Host-B 300b to negotiate the connection parameters, perform offset negotiation, and finalize the connection establishment, which is mentioned below.
a. ADV_EXT_IND 504: This is an advertising extended indication, which is a Bluetooth LE advertising packet that contains information about the advertising device (e.g., the Host-B 300b).
b. AUX_ADV_IND 505: This is an auxiliary advertising indication, which is an additional advertising packet that provides more information about the advertising device (e.g., the Host-B 300b).
c. AUX_CONNECT_REQ 506: This is an auxiliary connect request, where the Host-A 300a sends a request to connect to the Host-B 300b.
d. AUX_CONNECT_RSP (Offset Negotiation) 507: This is an auxiliary connect response, where the Host-B 300b responds to the connection request from the Host-A 300a, and the two devices negotiate the connection offset. For example, the two devices Host-A 300a and Host-B 300b may agree on the timing of their periodic connection events. The Host-A 300a may serve as a central electronic device, and the Host-B 300b may serve as a peripheral electronic device.
e. AUX_CONNECT_INDICATION 508: This is an auxiliary connect indication, which is a notification that the connection has been established.

At operations 509-510, an LE enhanced connection complete message is exchanged, indicating that the Bluetooth connection between the Host-A 300a and the Host-B 300b has been successfully established.

In some example embodiments, if the transmit window offset parameter is renegotiated, by a protocol data unit (PDU) of the AUX_CONNECT_RSP 507 (i.e., AUX_Connect RSP PDU), and an Implementation Under Test (IUT) in the peripheral electronic device (e.g., the Host-B 300b) can align anchor points of new LE connection without colliding eSCO anchor points, as illustrated in FIG. 6. The transmit window offset parameter may include various parameters as shown in Table-1 and Table-2.

TABLE 1
Payload

| | | |
|---|---|---|
| Extended Header | Adv Mode | Extended Header |
| Length | | |

TABLE 2
Extended Header

| Adv | Event | Adv | Target | Offset | Offset | Aux | Sync | Tx | | Adv |
|---|---|---|---|---|---|---|---|---|---|---|
| Mode | Type | A | A | Min | Max | Ptr | Info | Power | ACAD | Data |
| 0b11 | Connection | M | M | M | M | X | X | X | X | X |
| | response | | | | | | | | | |

In some example embodiments, after AUX_CONNECT_RSP PDU 507, the peripheral has to listen to at least one empty packet, of which a duration time is represented by T_{C→P}, sent from the central electronic device to the peripheral electronic device and respond back with at least one empty packet, of which a duration time is represented by T_{C→P}, sent from the peripheral electronic device to the central electronic device. Therefore, T_{C→P}(80 μs)+T_{IFS}(150 μs)+T_{C→P}(80 μs)=310 μs before the start of the eSCO anchor point is unusable as DUT will either not listen to the Central transmission or it won't respond due to collision with the Esco anchor point. For example, the time interval defined by TC→P (80 μs)+T_{IFS} (150 μs)+TC→P (80 μs), totaling 310 μs, immediately preceding the start of the eSCO anchor point may be considered unusable, as the Device Under Test (DUT) (e.g., the Host-B 300b as the peripheral electronic device) will either fail to listen to the central electronic device's transmission or be unable to respond, due to a timing collision with the eSCO anchor point. The IFS stands for Inter Frame Space, and T_{IFS} corresponds to a fixed time delay between two consecutive Bluetooth Link Layer packets exchanged between two devices (e.g., the Host-A and the Host-B). Therefore, out of the eSCO interval of 7.5 ms, the BLE-eSCO communication controller module 340 may get T_{C→P} (80 μs)+T_{IFS} (150 μs)+T_{C→P} (80 μs)+T_{TX}_{_{eSCO}}(625 μs)+T_{RX}_{_{eSCO}}(625 μs)=1.560 ms unresponsiveness which is proportionate to the connection drop rate. Connection drop rate=1.560/7.5=20.8%. By re-negotiating to available offset, the BLE-eSCO communication controller module 340 may minimize the connection drop rate to 0%. For example, out of the 7.5 ms eSCO interval, the BLE-eSCO communication controller module 340 may experience a period of unresponsiveness 1.560 ms, calculated as: totalling

$${T}_{C \to P} ( 80 μ s ) + {T}_{IFS} ( 150 μ s ) + {T}_{C \to P} ( 80 μ s ) + {T}_{{TX}_{eSCO}} ( 625 μ s ) + {T}_{RX \_ eSCO} ( 625 μ s ) .$$

This unresponsiveness corresponds to a connection drop rate of approximately 20.8% (1.560/7.5). By renegotiating the connection offset to align with available time slots, the BLE-eSCO communication controller module 340 may minimize the connection drop rate to 0%, thereby improving connection stability. TTX esco refers to the transmission time for an eSCO (extended Synchronous Connection-Oriented) packet in Bluetooth Classic communication, used for voice data such as hands-free audio. TRX esco refers to the receive duration for an eSCO packet, i.e., the time during which a device listens for and receives incoming eSCO audio data.

In some example embodiments, the AUX_CONNECT_INDICATION 508 comprises various parameters, as shown in Table-3 and Table-4

TABLE 3
Payload

| | | |
|---|---|---|
| Init A | AdvA | LLData |
| (6 Octets) | (6 Octets) | (22 Octets) |

TABLE 4
LL Data

| Field | AA | CRCInit | WinSize | WinOffset | Interval | Latency | Timeout | ChM | Hop | SCA |
|---|---|---|---|---|---|---|---|---|---|---|
| Size | 32 | 24 | 8 | 16 | 16 | 16 | 16 | 40 | 5 | 3 |
| in | | | | | | | | | | |
| bits | | | | | | | | | | |

In some example embodiments, the BLE-eSCO communication controller module 340 may manage the BLE communication link during an ongoing HFP call event. In response to initiation, by the first electronic device, the HFP call event with the third electronic device is maintained while receiving an incoming BLE connection from the first electronic device (serving as the central electronic device with respect to the second electronic device) to the second electronic device (serving as the peripheral electronic device with respect to the first electronic device). The second electronic device may operate as a central device for the third electronic device connection. The second electronic device may further identify one or more ongoing Bluetooth activities (e.g., HFP call event) and request for minimum and maximum offset parameter values for the HFP call event. One or more BLE connection events are scheduled in time gaps between eSCO packets, where a minimum offset corresponds to an end of the eSCO packet and a maximum offset corresponds to an end of the eSCO interval (TeSCO). The second electronic device may further determine the minimum and maximum offset parameter values. The BLE-eSCO communication controller module 340 may receive, by the first electronic device, the response message (e.g., AUX_CONNECT_RSP PDU 507) from the second electronic device, which includes the determined minimum and maximum offset parameter values. An offset may refer to a time delay or displacement from a reference point, used to control the scheduling of events such as data transmissions to avoid packet collisions between the BLE and the eSCO.

In some example embodiments, the BLE-eSCO communication controller module 340 may select, by the first electronic device, a final offset value based on the one or more identified ongoing Bluetooth activities in response to receiving the response message (e.g., AUX_CONNECT_RSP PDU 507).

In some example embodiments, the BLE-eSCO communication controller module 340 may transmit the indication message (e.g., AUX_CONNECT_INDICATION 508) to the second electronic device to configure the one or more BLE time intervals to exchange one or more BLE data packets between the first electronic device and the second electronic device based on the final offset value in response to receiving the response message.

For instance, consider a scenario where a user (Jack) is engaged in the HFP call using his Bluetooth headset (e.g., third electronic device) while receiving notifications on his smartphone (e.g., first electronic device). His smartwatch (e.g., second electronic device), connected to both the smartphone and the Bluetooth headset, manages these connections. During the call, the smartphone attempts to establish the BLE connection to the smartwatch, which recognizes the incoming request. To prevent interference with the ongoing call, the smartwatch monitors the Bluetooth activities, while the eSCO packets being transmitted. It identifies the timing of the eSCO packets and requests minimum and maximum offset values for scheduling BLE connection events. The minimum offset is set to the end of the current eSCO packet, while the maximum offset corresponds to the end of the eSCO interval (TeSCO). After calculating the optimal timing for the BLE connection, the smartwatch sends the AUX_CONNECT_RSP command (e.g., AUX_CONNECT_RSP PDU 507) to the smartphone, including the calculated offset values. The smartphone evaluates these proposed values, taking into account other ongoing Bluetooth activities, and selects the final offset value that allows the BLE connection to be established without disrupting Jack's call using the eSCO packet. As a result, the smartphone successfully connects to the smartwatch during designated gaps between the eSCO packets, enabling Jack to receive notifications and messages seamlessly while continuing his conversation, as illustrated in FIG. 6.

FIG. 7 illustrates a disproportionate connection interval technique 700 for establishing eSCO and BLE communication links simultaneously for multiple electronic devices, according to an embodiment as disclosed herein.

In some example embodiments, the BLE-eSCO communication controller module 340 may select the one or more BLE intervals that are disproportionate to one or more eSCO intervals and can avoid collision between one or more eSCO intervals and the BLE connection. The BLE-eSCO communication controller module 340 may ensure that the BLE connection event times do not significantly overlap the scheduled transmission of the eSCO data packet. Examples of the one or more disproportionate BLE intervals may include, but are not limited to, 8.75 ms, 25 ms, 37.5 ms, 50 ms, etc. For example, the BLE intervals are not integer multiples of the eSCO interval.

In some example embodiments, the BLE-eSCO communication controller module 340 may select the one or more BLE intervals that are not multiplier of one or more eSCO intervals, can effectively mitigate potential collisions, and ensure smoother operation across multiple concurrent connections within constrained bandwidth environments.

For instance, consider a scenario associated with a smart home environment where multiple electronic devices such as a smart thermostat, smart lights, and a fitness tracker communicate simultaneously via BLE and eSCO links, managing communication without collisions is essential for smooth operation. The eSCO interval, typically set at 7.5 milliseconds, defines the time between each eSCO event, allowing devices to exchange data efficiently. A critical aspect of this setup is the transmit window offset, which is the delay after an AUX_CONNECT_INDICATION 508 before the BLE device begins transmitting data. To avoid collisions, this offset should not align perfectly with the eSCO intervals.

For instance, if the BLE-eSCO communication controller module 340 sets the transmit window offset to 3 milliseconds, the BLE communication may start at this time after the connection indication. This timing is crucial, as it allows the BLE device to transmit data without interfering with ongoing eSCO events. The eSCO events occur at intervals of 0 ms, 7.5 ms, 15 ms, and so on. By starting the BLE transmission at 3 ms, the first anchor point for BLE data transmission is strategically positioned between the eSCO intervals, effectively preventing potential collisions between the BLE packets and the eSCO packets. This careful management of timing enhances the reliability of communication across multiple devices in the smart home, ensuring a seamless user experience. Ultimately, using disproportionate connection intervals allows for simultaneous communication among electronic devices without interference, optimizing performance and maintaining robust connectivity.

FIG. 8 illustrates an eSCO TX/RX technique 800 (suggested implementation) for establishing eSCO and BLE communication links simultaneously for multiple electronic devices, according to an embodiment as disclosed herein.

In some example embodiments, the BLE-eSCO communication controller module 340 may provide the eSCO Tx/Rx slots to the BLE connection to have a reliable BLE connection and send one or more skipped eSCO packets in one or more retransmission slots. As a result, one or more BLE anchor points may not collide with the eSCO packets, and both connections may be in sync without getting disconnection.

In some example embodiments, the BLE-eSCO communication controller module 340 may allocate transmission and reception eSCO intervals to establish the BLE communication link to exchange the one or more BLE data packets between the first electronic device and the second electronic device. The transmission and reception eSCO intervals refers to one or more time intervals allocated for sending and receiving the data packets between two connected device (e.g., the first electronic device and the second electronic device). The BLE-eSCO communication controller module 340 may further continually monitor transmission of the one or more eSCO data packets during the establishment of the BLE communication link. The BLE-eSCO communication controller module 340 may further determine whether any eSCO data packets were skipped during the establishment of the BLE communication link. For example, when being busy handling BLE connection setup, the second electronic device may fail to transmit or receive an eSCO packet for voice data because the second electronic device (i.e., may skip the eSCO packet received during the BLE connection setup). The BLE-eSCO communication controller module 340 may further perform one of the following.
a. Retransmitting the skipped eSCO data packets using designated retransmission intervals in response to the determining that any eSCO data packets were skipped during the establishment of the BLE communication link; or
b. continually monitoring the transmission of the one or more eSCO data packets during the establishment of the BLE communication link in response to determining that any eSCO data packets were not skipped during the establishment of the BLE communication link.

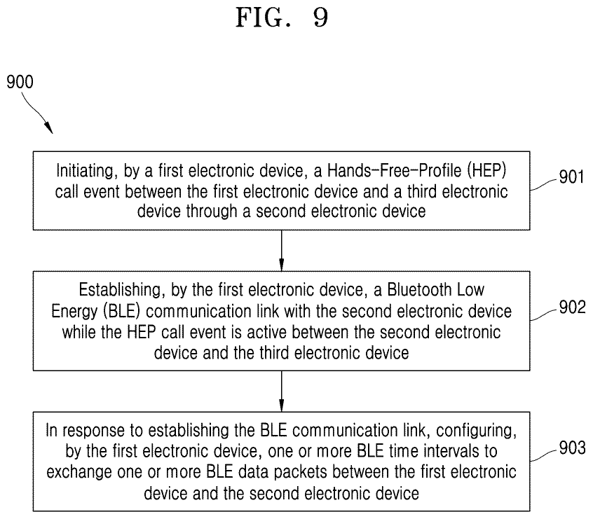

FIG. 9 is a flow diagram illustrating a method 900 for avoiding data packet collisions, according to an embodiment as disclosed herein. The method 900 may execute multiple operations to avoid data packet collisions, which are given below.

At operation 901, the method 900 includes initiating, by the first electronic device, the HFP call event between the first electronic device and the third electronic device through the second electronic device. The second electronic device and the third electronic device communicate using the eSCO communication link to exchange the one or more eSCO data packets during the one or more pre-defined eSCO time intervals. At operation 902, the method 900 includes establishing, by the first electronic device, the BLE communication link with the second electronic device while the HFP call event is active between the second electronic device and the third electronic device. At operation 903, the method 900 includes configuring, by the first electronic device, one or more BLE time intervals to exchange one or more BLE data packets between the first electronic device and the second electronic device in response to the establishing of the BLE communication link. The one or more BLE time intervals are distinct from the one or more pre-defined eSCO time intervals to avoid data packet collisions. Further, a detailed description related to the various steps of FIG. 9 is made with reference to FIG. 3, FIG. 4, FIG. 5, FIG. 6, FIG. 7, and FIG. 8, and is omitted herein for the sake of brevity.

For instance, in one embodiment, if the transmit window offset parameter is renegotiated by the AUX_Connect_RSP PDU, the IUT in a peripheral electronic device may align anchor points of the new BLE connection without colliding with eSCO anchor points. In addition, the AUX_Connect_REQ PDU can be transmitted by the peripheral electronic device with its suggested window offset similar to a PDU of an LMP_eSCO_LINK_REQ message, which is a Link Manager Protocol (LMP) message used in Bluetooth to initiate the establishment of an eSCO (extended Synchronous Connection-Oriented) link between two Bluetooth devices. The central device can resend the AUX_Connect_REQ with a matching window offset that can be accepted by the peripheral electronic device with the AUX_Connect_RSP, as described in conjunction with FIGS. 3 to 9.

In some example embodiments, the disclosed method/system has several advantages over the existing method, which are stated below.
a. The disclosed method/system allows the efficient and reliable establishment of BLE connections in scenarios where there are existing SCO or eSCO link connections between the electronic devices.
b. The disclosed method/system prevents link loss in a scattered network with the existence of both the BLE and eSCO connection between the peripheral electronic device and the central electronic device.
c. The disclosed method/system further reduces the occurrence of collision of the connection requests with the existing SCO or eSCO communication links.
d. The disclosed method/system furthermore by minimizing collisions ensures reliable connection thereby improving the overall network performance.
e. The disclosed method/system furthermore allows extended advertising by ensuring the efficient and reliable establishment of BLE connections.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method of avoiding data packet collisions, the method comprising:
initiating, by a first electronic device, a Hands-Free-Profile (HFP) call event between the first electronic device and a third electronic device through a second electronic device,
wherein the second electronic device and the third electronic device communicate using an extended Synchronous Connection-Oriented (eSCO) communication link to exchange one or more eSCO data packets during one or more pre-defined eSCO time intervals;
establishing, by the first electronic device, a Bluetooth Low Energy (BLE) communication link with the second electronic device while the HFP call event is active between the second electronic device and the third electronic device; and
in response to the establishing of the BLE communication link, configuring, by the first electronic device, one or more BLE time intervals to exchange one or more BLE data packets between the first electronic device and the second electronic device,
wherein the one or more BLE time intervals are distinct from the one or more pre-defined eSCO time intervals to avoid the data packet collisions between the one or more BLE data packets and the one or more eSCO data packets.

2. The method as claimed in claim 1,
wherein the configuring, by the first electronic device, of the one or more BLE time intervals to exchange the one or more BLE data packets between the first electronic device and the second electronic device comprises:
transmitting, by the first electronic device, a connection request to the second electronic device;
receiving, by the first electronic device, a response message from the second electronic device for offset negotiation; and
in response to receiving the response message, transmitting an indication message to the second electronic device to configure the one or more BLE time intervals to exchange the one or more BLE data packets between the first electronic device and the second electronic device.

3. The method as claimed in claim 2,
wherein the response message comprises a payload that comprises an extended header length, an Advertising Mode (Adv Mode), and an extended header, and
wherein the extended header comprises values corresponding to an advertising mode, an event type, an Advertising Address (Adv A), a Target Address (Target A), a minimum offset value (Offset Min), a maximum offset value (Offset Max), an Auxiliary Pointer value (Aux Ptr), Synchronization Information (Sync Info), Transmit Power value (Tx Power), Advertising Channel Assessment Data (ACAD), and Advertising Data (Adv Data).

4. The method as claimed in claim 2,
wherein the indication message contains a payload that comprises an Initial Address (Init A), an Advertising Address (Adv A), and Link Layer Data (LLData), and
wherein the LLData comprises values corresponding to Access Address (AA), CRC Initialization (CRCInit), Window Size (WinSize), Window Offset (WinOffset), Interval, Latency, Timeout, Channel Map (ChM), Hop value, and Sleep Clock Accuracy (SCA).

5. The method as claimed in claim 2, further comprising:
managing the BLE communication link during an ongoing HFP call event so that an incoming BLE connection from the first electronic device to the second electronic device is made at the one or more BLE time intervals,
wherein the second electronic device operates as a central device for the third electronic device,
wherein the second electronic device identifies one or more ongoing Bluetooth activities and requests for a minimum offset parameter value for the HFP call event and a maximum offset parameter value for the HFP call event,
wherein one or more BLE connection events are scheduled in time gaps between eSCO packets, where a minimum offset corresponds to an end of one of the eSCO packets and a maximum offset corresponds to an end of an eSCO interval (TeSCO), and
wherein the second electronic device determines the minimum offset parameter value and the maximum offset parameter value;
receiving, by the first electronic device, the response message from the second electronic device, which includes the minimum offset parameter value and the maximum offset parameter value;
in response to receiving the response message, selecting, by the first electronic device, a final offset value based on the one or more identified ongoing Bluetooth activities; and
in response to receiving the response message, transmitting the indication message to the second electronic device to configure the one or more BLE time intervals to exchange the one or more BLE data packets between the first electronic device and the second electronic device based on the final offset value.

6. The method as claimed in claim 1,
wherein the configuring, by the first electronic device, of the one or more BLE time intervals to exchange the one or more BLE data packets between the first electronic device and the second electronic device comprises:
determining, by the first electronic device, the one or more pre-defined eSCO time intervals; and
determining, by the first electronic device, the one or more BLE time intervals that are distinct or disproportionate from the one or more pre-defined eSCO time intervals to avoid the data packet collisions.

7. The method as claimed in claim 1,
wherein the configuring, by the first electronic device, of the one or more BLE time intervals to exchange the one or more BLE data packets between the first electronic device and the second electronic device comprises:
performing, by the second electronic device, at least one of:
allocating transmission and reception eSCO intervals to establish the BLE communication link to exchange the one or more BLE data packets between the first electronic device and the second electronic device;
continually monitoring transmission of the one or more eSCO data packets in the establishing, by the first electronic device, the BLE communication link;
determining whether any eSCO data packet was skipped in the establishing, by the first electronic device, the BLE communication link; and
performing one of:
retransmitting the skipped eSCO data packets using designated retransmission intervals in response to the determining that any eSCO data packet was skipped during the establishment of the BLE communication link, and
continually monitoring the transmission of the one or more eSCO data packets during a time when the BLE communication link is established in response to determining that any eSCO data packet was not skipped in the establishing, by the first electronic device, the BLE communication link.

8. The method as claimed in claim 1, further comprising:
retrying, by the first electronic device, BLE communication link establishment after a failure of a first connection establishment attempt.

9. The method as claimed in claim 1,
wherein the first electronic device operates as a central device connecting the second electronic device and the third electronic device as peripheral devices and manages a call via traditional technique or by using the second electronic device as an intermediary for hands-free calling experiences,
wherein the second electronic device operates as a central device for the third electronic device while operating as a peripheral device to the first electronic device, and
wherein the third electronic device connects to either the first electronic device or the second electronic device and operates as a peripheral device to the first electronic device or the second electronic device to receive one or more commands from the first electronic device or the second electronic device and transmit audio signals to the first electronic device or the second electronic device.

10. A system for avoiding data packet collisions between a BLE data packet and an eSCO data packet comprising:
a memory;
a processor;
a communicator circuit; and
a BLE-eSCO communication controller circuit operably connected to the memory, the processor, and the communicator circuit, and configured to:
initiate, by a first electronic device, a Hands-Free-Profile (HFP) call event between the first electronic device and a third electronic device through a second electronic device,
wherein the second electronic device and the third electronic device communicate using an extended Synchronous Connection-Oriented (eSCO) communication link to exchange one or more eSCO data packets during one or more pre-defined eSCO time intervals;
establish a Bluetooth Low Energy (BLE) communication link with the second electronic device while the HFP call event is active between the second electronic device and the third electronic device; and
in response to the establishing of the BLE communication link, configure one or more BLE time intervals to exchange one or more BLE data packets between the first electronic device and the second electronic device,
wherein the one or more BLE time intervals are distinct from the one or more pre-defined eSCO time intervals to avoid the data packet collisions, and
wherein each of the first electronic device and the second electronic device includes the system.

11. The system as claimed in claim 10,
wherein to configure the one or more BLE time intervals to exchange the one or more BLE data packets between the first electronic device and the second electronic device, the BLE-eSCO communication controller circuit of the first electronic device is configured further to:
transmit a connection request to the second electronic device;
receive a response message from the second electronic device for offset negotiation; and
in response to receiving the response message, transmit an indication message to the second electronic device to configure the one or more BLE time intervals to exchange the one or more BLE data packets between the first electronic device and the second electronic device.

12. The system as claimed in claim 11,
wherein the response message comprises a payload that comprises an extended header length, an Advertising Mode (Adv Mode), and an extended header, and
wherein the extended header comprises values corresponding to an advertising mode, an event type, an Advertising Address (Adv A), a Target Address (Target A), a minimum offset value (Offset Min), a maximum offset value (Offset Max), an Auxiliary Pointer value (Aux Ptr), Synchronization Information (Sync Info), Transmit Power value (Tx Power), Advertising Channel Assessment Data (ACAD), and Advertising Data (Adv Data).

13. The system as claimed in claim 11,
wherein the indication message contains a payload that comprises an Initial Address (Init A), an Advertising Address (Adv A), and Link Layer Data (LLData), and
wherein the LLData comprises values corresponding to Access Address (AA), CRC Initialization (CRCInit), Window Size (WinSize), Window Offset (WinOffset), Interval, Latency, Timeout, Channel Map (ChM), Hop value, and Sleep Clock Accuracy (SCA).

14. The system as claimed in claim 11,
wherein the BLE-eSCO communication controller circuit of the first electronic device is configured further to:
mange the BLE communication link during an ongoing HFP call event so that an incoming BLE connection from the first electronic device to the second electronic device is made at the one or more BLE time intervals,
wherein the second electronic device operates as a central device for the third electronic device connection,
wherein the BLE-eSCO communication controller circuit of the second electronic device is configured to identify one or more ongoing Bluetooth activities and request for a minimum offset parameter value for the HFP call event and a maximum offset parameter value for the HFP call event,
wherein the BLE-eSCO communication controller circuit of the first electronic device is configured further to schedule one or more BLE connection events in time gaps between eSCO packets, where a minimum offset corresponds to an end of the eSCO packet and a maximum offset corresponds to an end of the eSCO interval (TeSCO), and
wherein the BLE-eSCO communication controller circuit of the second electronic device is configured further to determine the minimum offset parameter value and the maximum offset parameter value;
receive, by the first electronic device, the response message from the second electronic device, which includes the minimum offset parameter value and the maximum offset parameter value;
in response to receiving the response message, select, by the first electronic device, a final offset value based on the one or more identified ongoing Bluetooth activities; and
in response to receiving the response message, transmit, by the first electronic device, the indication message to the second electronic device to configure the one or more BLE time intervals to exchange the one or more BLE data packets between the first electronic device and the second electronic device based on the final offset value.

15. The system as claimed in claim 10,
wherein to configure the one or more BLE time intervals to exchange the one or more BLE data packets between the first electronic device and the second electronic device, the BLE-eSCO communication controller circuit of the first electronic device is configured further to:
determine the one or more pre-defined eSCO time intervals; and
determine the one or more BLE time intervals that are distinct or disproportionate from the one or more pre-defined eSCO time intervals to avoid the data packet collisions.

16. The system as claimed in claim 10,
wherein to configure the one or more BLE time intervals to exchange the one or more BLE data packets between the first electronic device and the second electronic device, the BLE-eSCO communication controller circuit of the second electronic device is configured to:
perform, by the second electronic device, at least one of:
allocate transmission and reception eSCO intervals to establish the BLE communication link to exchange the one or more BLE data packets between the first electronic device and the second electronic device;
continually monitor transmission of the one or more eSCO data packets in the establishing, by the first electronic device, the BLE communication link;
determine whether any eSCO data packet was skipped in the establishing, by the first electronic device, the BLE communication link; and
perform one of:
retransmit the skipped eSCO data packets using designated retransmission intervals in response to the determining that any eSCO data packet was skipped during the establishment of the BLE communication link, and
continually monitor the transmission of the one or more eSCO data packets at a time when the BLE communication link is established in response to the determining that any eSCO data packet was not skipped in the establishing, by the first electronic device, the BLE communication link.

17. The system as claimed in claim 10,
wherein the BLE-eSCO communication controller circuit of the first electronic device is configured further to:
retry BLE communication link establishment after a failure of a first connection establishment attempt.

18. The system as claimed in claim 10, comprising:
wherein the first electronic device operates as a central device connecting the second electronic device and the third electronic device as peripheral devices and manages a call via traditional technique or by using the second electronic device as an intermediary for hands-free calling experiences,
wherein the second electronic device operates as a central device for the third electronic device while operating as a peripheral device to the first electronic device, and
wherein the third electronic device connects to either the first electronic device or the second electronic device and operates as a peripheral device to the first electronic device or the second electronic device to receive one or more commands from the first electronic device or the second electronic device and transmits audio signals to the first electronic device or the second electronic device.

19. A smartphone comprising:
a memory;
a processor;
a communicator circuit; and
a BLE-eSCO communication controller circuit, operably connected to the memory, the processor, and the communicator circuit,
wherein the BLE-eSCO communication controller circuit is configured to:
initiate a Hands-Free-Profile (HFP) call event between the smartphone and a first peripheral device through a second peripheral device that is connected to the first peripheral device using an extended Synchronous Connection-Oriented (eSCO) communication link to exchange at least one eSCO data packet during a pre-defined eSCO time interval;
establish a Bluetooth Low Energy (BLE) communication link with the second peripheral device while the HFP call event is active between the peripheral device and the second peripheral device; and
in response to the establishing of the BLE communication link, configure at least one BLE time interval to exchange at least one BLE data packet between the first smartphone and the first peripheral device,
wherein the at least one BLE time interval is distinct from the at least one pre-defined eSCO time interval to avoid data packet collision between the at least one BLE data packet and the at least one eSCO data packet.

20. The smartphone of claim 19,
wherein to configure the at least one BLE time interval, the BLE-eSCO communication controller is configured further to:
transmit a connection request to the first peripheral device;
receive a response message from the first peripheral device for offset negotiation; and
in response to receiving the response message, transmit an indication message to the first peripheral device to configure the at least one BLE time intervals to exchange at least one BLE data packets between the smartphone and the first peripheral device.
